(19) United States
(12) Patent Application Publication
(10) Pub. No.: US 2020/0233687 A1
(43) Pub. Date: Jul. 23, 2020

(54) USER SPACE PCI DEVICE EMULATION FOR PEER PROCESSES

(71) Applicant: Nutanix, Inc., San Jose, CA (US)

(72) Inventors: Felipe Franciosi, Cambridge (GB); Jonathan Davies, San Jose, CA (US)

(73) Assignee: Nutanix, Inc., San Jose, CA (US)

(21) Appl. No.: 16/251,048

(22) Filed: Jan. 17, 2019

(51) Int. Cl. G06F 9/455; G06F 13/42

(52) U.S. Cl. CPC G06F 9/45558; G06F 2213/0024; G06F 2009/45579; G06F 13/4221

(57) ABSTRACT

A system and method include receiving, at a host device, a request from a virtual machine to communicate with an emulated device. The host device establishes a socket connection between an emulator and the emulated device and communicates input-output messages via the socket connection from the virtual machine to the emulated device where the input-output messages use a virtual function input/output (VFIO) message protocol.

### BACKGROUND

The following description is provided to assist the understanding of the reader. None of the information provided or references cited is admitted to be prior art.

Virtual computing systems are widely used in a variety of applications. Virtual systems can include a computer on which a hypervisor, or virtual machine monitor, runs. The hypervisor is computer software, firmware, or hardware that creates and runs virtual machines. The hypervisor can emulate a certain piece of hardware that it presents to a guest virtual machine (VM) regardless of where the hardware is physically located.

User space is generally understood to be the portion of system memory in which user processes run. In contrast, kernel space is the portion of memory in which the kernel executes and provides services.

### SUMMARY

In accordance with at least some aspects of the present disclosure, a method of user space PCI device emulation is disclosed. The method includes receiving, at a host device, a request to communicate with an emulated device; establishing, at the host device, a socket connection between an application in user space at the host device and the emulated device; and communicating input-output messages via the socket connection from the application to the emulated device, wherein the input-output messages use a virtual function input/output (VFIO) message protocol.

In accordance with some other aspects of the present disclosure, a host device is disclosed. The host device includes a kernel including operating system functionality and a user space including a device emulator and an application. The application requests communication with an emulated device located in the user space and establishes a socket connection with the emulated device, and wherein the application and the emulated device communicate input-output messages via the socket connection where the input-output messages use a virtual function input/output (VFIO) message protocol.

In accordance with yet other embodiments of the present disclosure, a non-transitory computer readable media is disclosed. The non-transitory computer readable media includes computer-executable instructions that, when executed by a processor of a virtual computing system, cause the virtual computing system to perform a process. The process includes receiving, at a host device, a request to communicate with an emulated device; establishing, at the host device, a socket connection between an application in user space at the host device and the emulated device; and communicating input-output messages via the socket connection from the application to the emulated device, wherein the input-output messages use a virtual function input/output (VFIO) message protocol.

The foregoing summary is illustrative only and is not intended to be in any way limiting. In addition to the illustrative aspects, embodiments, and features described above, further aspects, embodiments, and features will become apparent by reference to the following drawings and the detailed description.

### BRIEF DESCRIPTION OF THE DRAWINGS

FIG. 1 is a block diagram of a system including hardware controlled by applications at a host, in accordance with a conventional implementation.

FIG. 2 is a block diagram of the system of FIG. 1 including a VFIO-PCI interface in accordance with a conventional implementation.

FIG. 3 is a block diagram of the system of FIG. 1 including an emulator in user space in accordance with a conventional implementation.

FIG. 4 is a block diagram of a system including a virtual machine and a device emulator in accordance with another conventional implementation.

FIG. 5 is a block diagram of a system including an emulation device and an emulator, in accordance with some implementations of the present disclosure.

FIG. 6 is a block diagram of a system including an application in user space communicating with an NVMe Device using a VFIO-PCI driver in a kernel in accordance with a conventional implementation.

FIG. 7 is a block diagram of a system including an application in user space communicating with an emulation of an NVMe Device in user space, in accordance with some implementations of the present disclosure.

FIG. 8 is a flowchart outlining operations for user space peripheral component interconnect (PCI) device emulation, in accordance with some implementations of the present disclosure.

The foregoing and other features of the present disclosure will become apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and make part of this disclosure.

The present disclosure is generally directed to a system for emulating processes in user space. More specifically, the present disclosure describes using virtual function input-output (VFIO) protocol together with UNIX sockets to emulate peripheral component interconnect (PCI) devices in user space between processes.

A host device generally includes both user space memory locations in which user processes run and a kernel that executes and provides services for the host device. Applications in user space that utilize drivers in the kernel can interact with hardware and memory external to the host device. The kernel limits access that the application has to only parts of external memory belonging to that application. In contrast, applications executing in user space that do not utilize a kernel driver may be able to access any memory without the same limitations imposed by the kernel driver.

Advantageously, the present disclosure describes a system in which a virtual machine (VM) emulator provides a virtual machine with a virtual PCI device that is backed by a user space process. When a driver performs operations such as reading or writing to the virtual PCI device's control registers, each operation corresponds to one or more messages that are sent by the VM emulator to a user space device emulator process via a virtual function input/output (VFIO) message protocol.

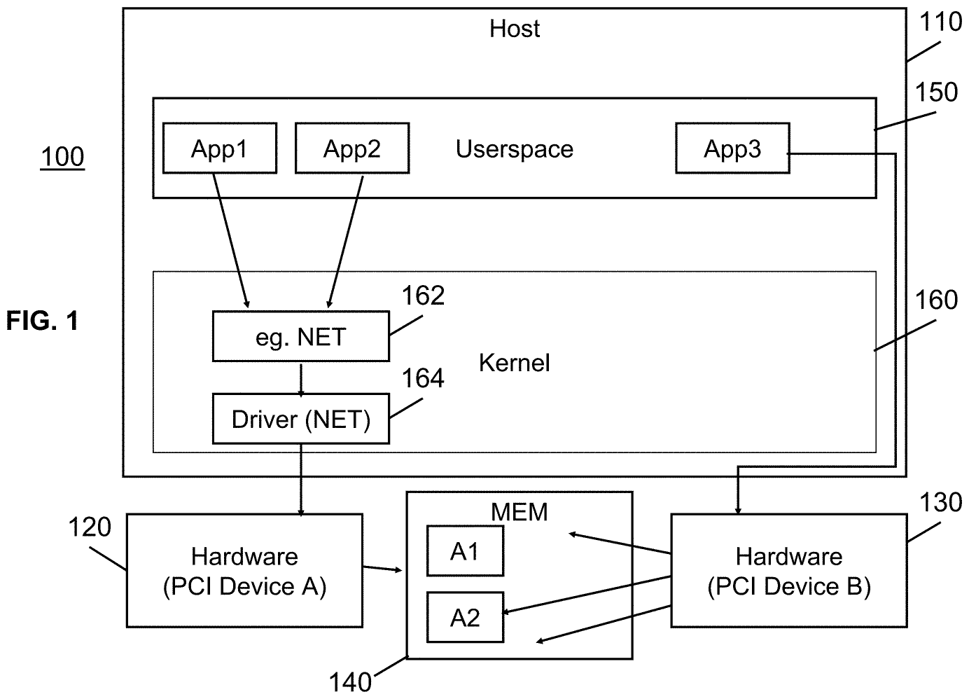

FIG. 1 illustrates a system 100 including a host device 110, a hardware device 120, a hardware device 130, and memory 140. The host device 110 includes a user space 150 and a kernel 160. The user space 150 can include multiple applications such as App1, App2, and App3. The kernel 160 can include an interface 162 such as a .NET interface and a driver 164. Applications in the user space 150 such as App1 and App2 can access hardware 120 via the interface 162 and driver 164. Applications in the user space 150 such as App3 can access hardware 130 directly without use of the kernel 160. The kernel 160, however, ensures that App1 and App2 only access parts of memory belonging to the respective applications in memory 140. In contrast, when App3 accesses hardware 130 directly from user space, App3 may be able to access any memory in memory 140, not just memory belonging to App3.

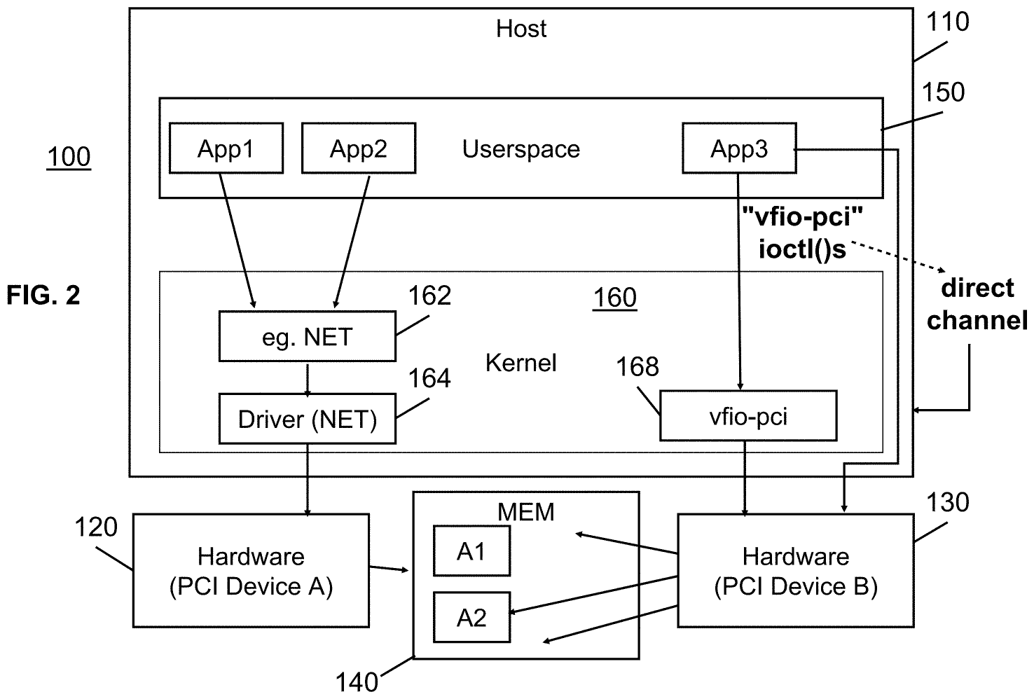

FIG. 2 illustrates the system 100 with a virtual function input-output (VFIO)-PCI driver 168 in the kernel 160 such that App3 is restricted to access of certain memory in memory 140 when using hardware 130. App3 communicates with VFIO driver 168 using VFIO-PCI input output controls (ioctl( )s). While the addition of the VFIO-PCI driver 168 improves the system 100 with added controls on memory access, the additional driver adds complexity and processing.

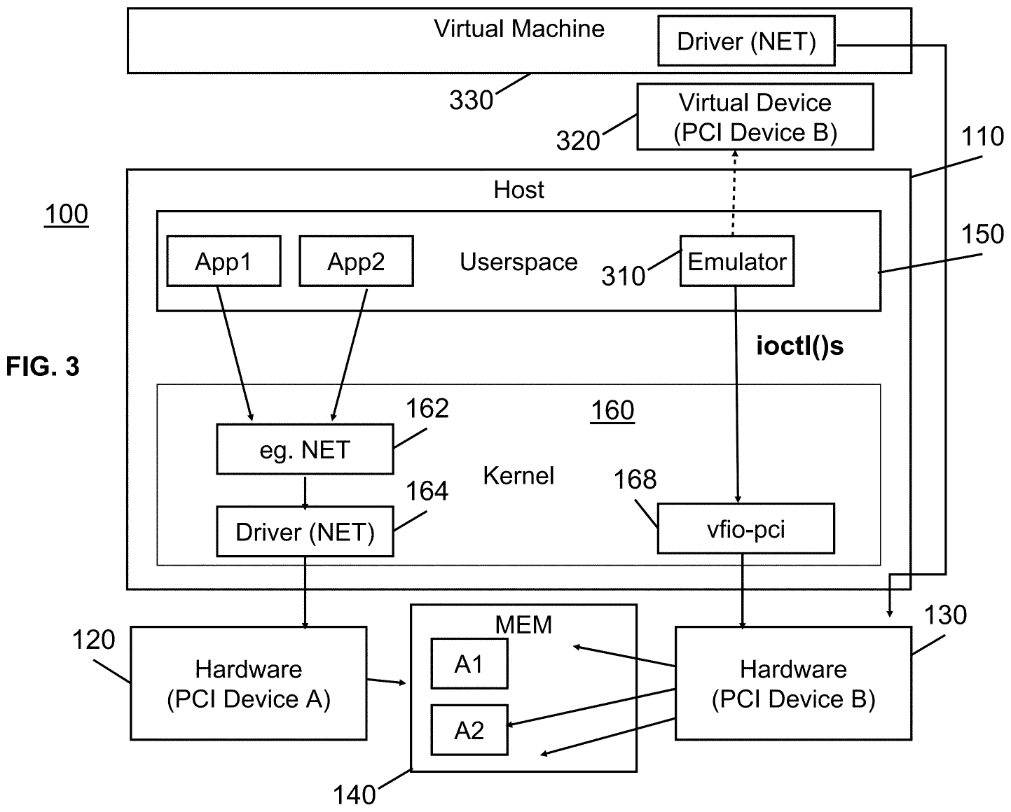

FIG. 3 illustrates the system 100 with an emulator 310 running in the user space 150. The emulator 310 emulates hardware device 130 to provide a virtual device 320 that can be accessed by a virtual machine 330. One disadvantage to system 100 is that the device function is completely owned by the emulator 310. As such, it can only be accessed by virtual machine 330. If the device could be emulated by a separate piece of user space software (e.g. a device emulator), then other virtual machines could also present virtual devices backed by the device emulator. The device emulator, in turn, could mediate access to a real physical device (or not).

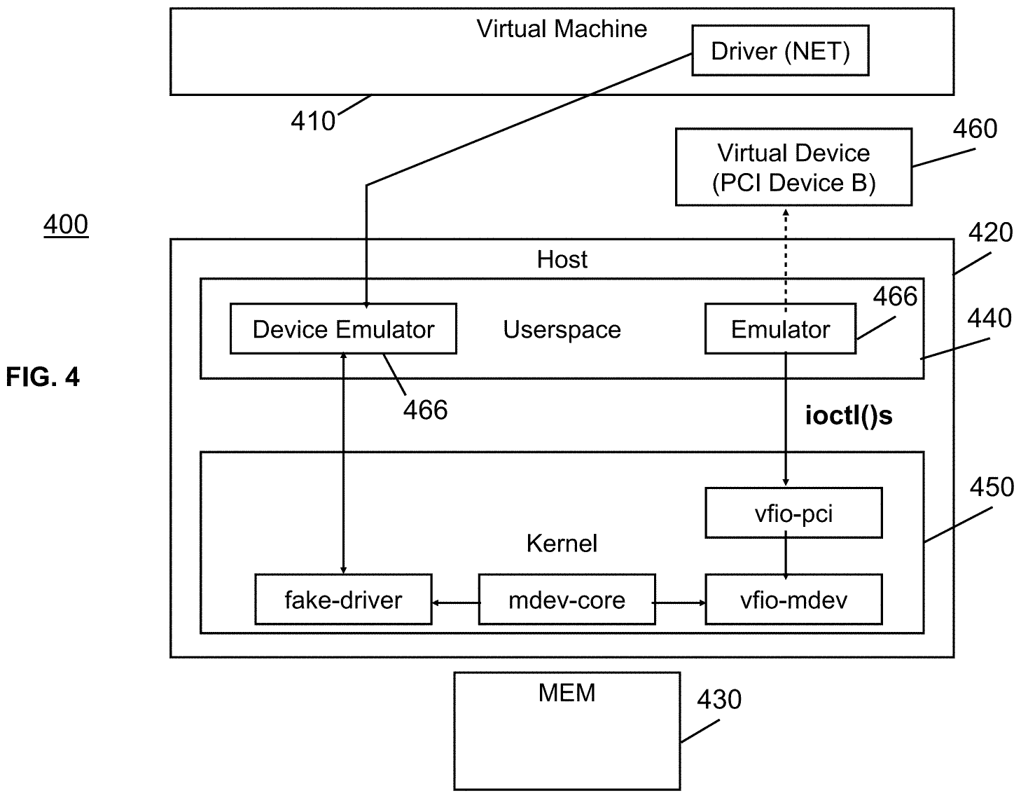

FIG. 4 illustrates a system 400 having a virtual machine 410, a host device 420, and memory 430. The host device includes a user space 440 and a kernel 450. The user space 440 includes an emulator 454 that emulates a hardware device to provide a virtual device 460. The user space 440 also includes a device emulator 466 coupled to a driver in the virtual machine 410. The device emulator 466 utilizes processes running on the kernel 450, including a fake driver to provide device emulation. One disadvantage to system 400 is involving kernel code when this is not really necessary. Kernel is typically licensed as GPL which imposes restrictions on software that is distributed and used with it.

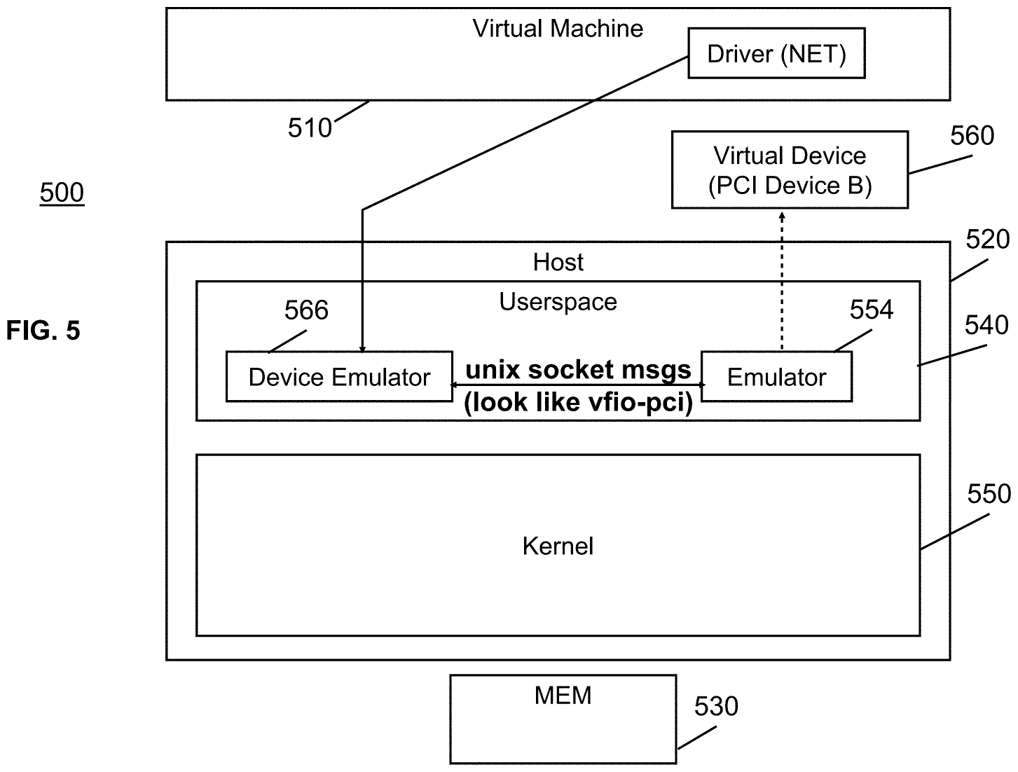

FIG. 5 illustrates a system 500 having a virtual machine 510, a host device 520, and memory 530. The host device includes a user space 540 and a kernel 550. The user space 540 includes an emulator 554 that emulates a hardware device to provide a virtual device 560. The user space 540 also includes a device emulator 566 coupled to a driver in the virtual machine 510. In contrast to system 400 described with reference to FIG. 4, the device emulator 566 does not utilize any processes in the kernel 550 but rather communicates with the emulator directly using UNIX socket messages. The UNIX socket messages are configured to appear like VFIO-PCI messages to the emulator 554. In alternative embodiments, other protocols may be used for communication between the device emulator 566 and the emulator 554. Advantageously, the system 500 uses a VFIO-PCI protocol with a UNIX socket to emulate PCI devices in user space between processes. Such a system moves the protocol from the kernel 550 to the user space 540.

There are at least two advantages to the system 500. First, avoiding the kernel for this device emulation setup allows for non-GPL software implementation of devices, which can be important for both licensing and distribution. Second, emulating devices from a single user space process (outside of the virtual machine emulator) has added performance benefits such as efficient instruction caching and polling. That is, a single process can efficiently run a set of instructions which query multiple virtual devices for work in a tight loop. Doing the same from multiple (e.g. virtual machine) emulators can only be done for devices within the virtual machine handled by that emulator. As a result, CPU time is used inefficiently as multiple CPUs are required to sit in a tight loop for multiple virtual machines (therefore wasting CPU cycles and power).

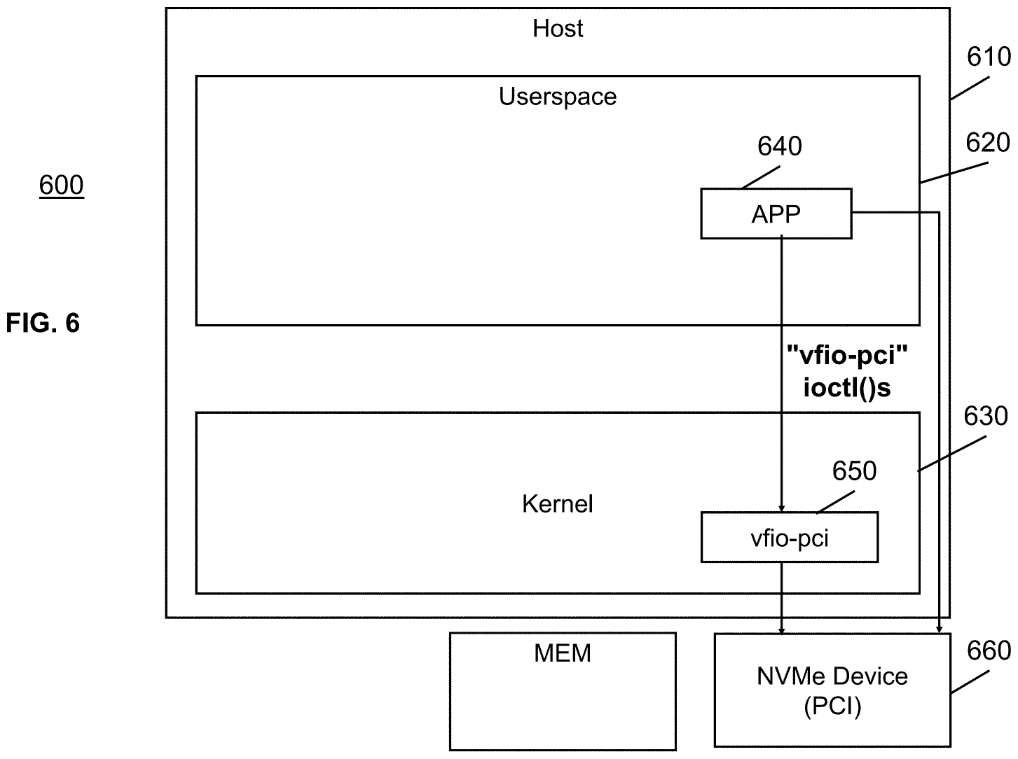

FIG. 6 illustrates a system 600 having a host device 610 with a user space 620 and kernel 630. The user space 620 includes an application 640 that communicates with a VFIO-PCI driver 650 in the kernel 630 to communicate with a NVMe (non-volatile member express) device 660. System 600 demonstrates that application 640 in user space 620 can utilize a driver in the kernel 630 to interface with the NVMe device 660.

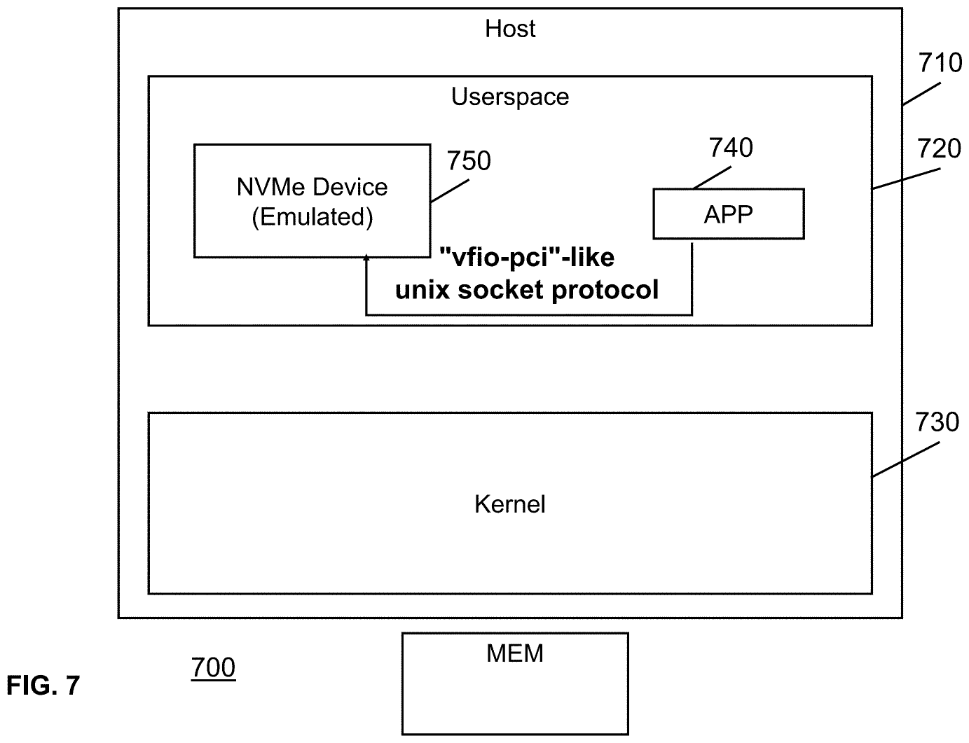

FIG. 7 illustrates a system 700 having a host device 710 with a user space 720 and kernel 730. The user space 720 includes an application 740 that communicates with an emulation of a NVMe device 750 using a VFIO protocol. In contrast with system 600 described with reference to FIG. 6, system 700 emulates the NVMe device 750 rather than connecting to a NVMe device via a driver in the kernel. Emulating the device in use rspace has numerous advantages. For example, as noted above, avoiding the kernel for this device emulation setup allows for non-GPL software implementation of devices, which can be important for both licensing and distribution. Second, it is arguably safer and more secure to constrain user space software if compared to kernel. Software running in the kernel, if faulty, can compromise the security of an entire host. Further, it is arguably simpler to implement and test software in user space.

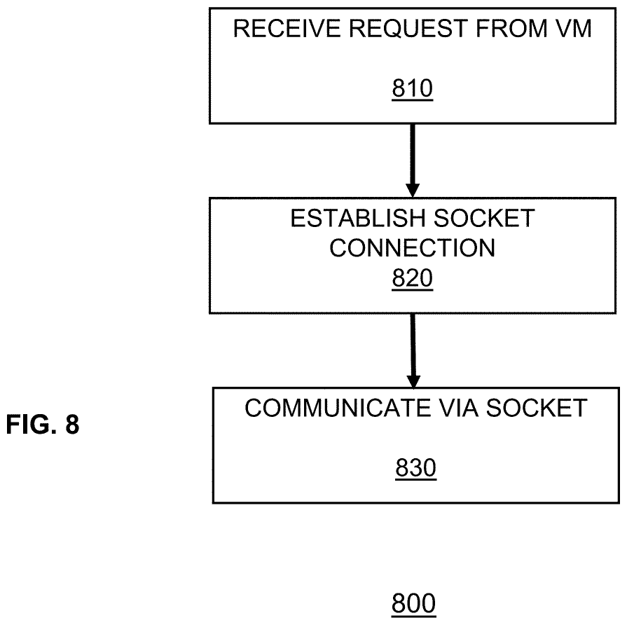

FIG. 8 is a flowchart outlining operations for user space PCI device emulation, in accordance with some implementations of the present disclosure. Additional, fewer, or different operations may be performed in the method depending on the implementation and arrangement. The method 800 includes receiving, at a host device, a request from a virtual machine to communicate with an emulated device (810); establishing, at the host device, a socket connection with an emulator (820); and communicating input-output messages via the socket connection (830). The input-output messages appear to use virtual function input/output (VFIO) message protocol.

In operation 810, a virtual machine or any computing device sends a request to a host device to communicate with a device that the host device is emulating. An emulated device is a device that is not necessarily physically located at the host device but the emulation enables requesting devices to utilize the services provided by the emulated device.

In operation 820, the host device includes user space memory where a device emulator establishes a socket connection with an emulator. The socket connection can be, for example, a UNIX socket connection. In operation 830, after the socket connection is established, the device emulator communicates input and output control messages using the socket connection. The input-output messages appear similar to and functionally equivalent to VFIO-PCI messages such as those used in system 400 described with reference to FIG. 4. Advantageously, the method enables the use of VFIO-PCI protocol together with UNIX sockets to emulate PCI devices in userspace between processes. The sockets used in the embodiments described herein allow for passing of file descriptors which can facilitate the secure sharing of memory mappings, although other mechanisms exist for that.

Advantageously, the embodiments described herein emulate all kinds of PCI devices, not just network devices. For example, the embodiments can be used to emulate a storage device, a GPU, an audio device, a modem, a USB controller, etc. The embodiments emulate an entire PCI device that a driver running in a VM can drive as if it were a physical device.

The embodiments enable an emulator to present virtual hardware to a virtual machine by configuring the virtual hardware to present a virtual PCI device backed by a user space device emulator. When a driver performs operations such as reading or writing to the virtual PCI device's control registers, each operation corresponds to one or more messages that are sent by the virtual hardware to the user space device emulator process via a virtual function input/output (VFIO) message protocol.

The various illustrative logical blocks, modules, circuits, and algorithm steps described in connection with the examples disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The hardware used to implement the various illustrative logics, logical blocks, modules, and circuits described in connection with the examples disclosed herein may be implemented or performed with a general purpose processor, a DSP, an ASIC, an FPGA or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In some exemplary examples, the functions described may be implemented in hardware, software, firmware, or any combination thereof. If implemented in software, the functions may be stored as one or more instructions or code on a non-transitory computer-readable storage medium or non-transitory processor-readable storage medium. The steps of a method or algorithm disclosed herein may be embodied in a processor-executable software module which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances, where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, unless otherwise noted, the use of the words “approximate,” “about,” “around,” “substantially,” etc., mean plus or minus ten percent.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

1. A method comprising:
receiving, at a host device, a request to communicate with an emulated device;
establishing, at the host device, an inter-process communication connection between an application in user space at the host device and the emulated device; and
communicating an input-output message via the inter-process communication connection from the application to the emulated device, wherein the input-output message uses a message protocol.

2. The method of claim 1, wherein the inter-process communication connection is a UNIX socket connection.

3. The method of claim 7, wherein the storage device is a non-volatile memory (NVMe) device.

4. The method of claim 1, wherein the application receives the request to communicate with the emulated device from a virtual machine coupled to the application in the user space of the host device.

5. The method of claim 1, wherein the application is an emulator.

6. The method of claim 5, wherein the emulator and the emulated device are located in the user space of the host device.

7. The method of claim 1, wherein the emulated device is a storage device or a network device.

8. The method of claim 1, wherein the emulated device is a peripheral component interconnect (PCI) device.

9. The method of claim 1, wherein the message protocol is a virtual function input/output message protocol.

10. The method of claim 1, wherein the message protocol is a virtual function input/output-like message protocol.

11. The method of claim 10, wherein the emulated device controls a portion of an external memory that is accessible to the application in the user space at the host device using the emulated device.

12. A host device comprising:
a user space including a device emulator and an application,
wherein the application requests communication with an emulated device associated with the user space and establishes an inter-process communication connection with the emulated device upon receiving a request via the device emulator;
wherein the application and the emulated device communicate an input-output message via the inter-process communication connection; and
wherein the input-output message uses a message protocol.

13. The host device of claim 12, wherein the inter-process communication connection is a UNIX socket connection.

14. The host device of claim 12, wherein the emulated device is a storage device or a network device.

15. The host device of claim 12, wherein the application receives the request to communicate with the emulated device from a virtual machine coupled to the application in the user space of the host device.

16. The host device of claim 12, wherein the application is an emulator.

17. The host device of claim 16, wherein the emulator and the emulated device are located in the user space of the host device.

18. A non-transitory computer readable media with computer-executable instructions embodied thereon that, when executed by a processor of a virtual computing system, cause the virtual computing system to perform a process comprising:
receiving, at a host device, a request to communicate with an emulated device;
establishing, at the host device, an inter-process communication connection between an application in user space at the host device and the emulated device; and
communicating an input-output message via the inter-process communication connection from the application to the emulated device, wherein the input-output message uses a message protocol.

19. The non-transitory computer readable media of claim 18, wherein the application receives the request to communicate with the emulated device from a virtual machine coupled to the application in the user space of the host device.

20. The non-transitory computer readable media of claim 18, wherein the message protocol is a virtual function input/output message protocol or a virtual function input/output-like message protocol.
